(19) United States
(12) Patent Application Publication
(10) Pub. No.: US 2009/0102086 A1
(43) Pub. Date: Apr. 23, 2009

(54) METHOD FOR PRODUCING A COATED THERMOPLASTIC MATERIAL

(75) Inventors: MATTHIAS SIEVERDING, Newton, NC (US); Jochen Zwiesele, Leiude (DE); Marco Gruber, Munchen (DE); Jochen Mitzler, Dachau (DE)

Correspondence Address: Henry M. Feiereisen;Henry M. Feiereisen. LLC, Suite 1501, 708 Third Avenue, New York, NY, 10017, US

(73) Assignee: KraussMaffei Technologies GmbH, Munchen (DE)

(21) Appl. No.: 12/264,545

(22) Filed: Nov. 4, 2008

Related U.S. Application Data
(63) Continuation of application No. PCT/EP2007/053542, filed on Apr. 12, 2007.

(30) Foreign Application Priority Data
May 4, 2006 (DE) 10 2006 020 696.7

(51) Int. Cl. B28B 11/04

(52) U.S. Cl. 264/131

(57) ABSTRACT

In a method for producing a coated thermoplastic material, thermoplastic material is fed into a twin-screw extruder to produce a homogenous melt as the thermoplastic material is advanced. While the melt is in plastic state an adhesion promoter for a coating material to be applied later or a small amount of a coating material to be applied later as adhesion promoter is added to the melt which is then transferred to an injection mold and allowed to cure to form a thermoplastic body. The thermoplastic body is then coated with the coating material.

### CROSS-REFERENCES TO RELATED APPLICATIONS

This application is a continuation of prior filed copending PCT International application no. PCT/EP2007/053542, filed Apr. 12, 2007, which designated the United States and has been published but not in English as International Publication No. WO 2007/128645 and on which priority is claimed under 35 U.S.C. §120, and which claims the priority of German Patent Application, Serial No. 10 2006 020 696.7, filed May 4, 2006, pursuant to 35 U.S.C. 119(a)-(d), the contents of which are incorporated herein by reference in its entirety as if fully set forth herein.

### BACKGROUND OF THE INVENTION

The present invention relates to a method for producing a coated thermoplastic material.

Nothing in the following discussion of the state of the art is to be construed as an admission of prior art.

Coated thermoplastic materials involve a thermoplastic base body which is coated with the coating material. A problem encountered heretofore is the realization of a sufficient adhesion of the coating material upon the thermoplastic base body. There are polymer materials or mixtures that are not compatible with one another, and there are materials that cannot bond with the surface of a thermoplastic material. In this context, reference is made to table 8.6, on page 694, in Soechtling, Kunststofftaschenbuch [Plastic Paperback], 29th edition, 2004, which lists the applicability of plastic combinations in 2-component injection molding processes. This table shows that some materials exhibit good bonding with one another and some materials none whatsoever.

Attempts to ensure sufficient adhesion of the coating material onto a thermoplastic material involves various intermediate treatment steps, e.g. activation of the surface of the thermoplastic material through flame treatment, or incorporation of a plasma treatment step between the production of the thermoplastic material and the coating process. A partly or fully ionized gas is hereby oftentimes used in a low-pressure process, with monomers being introduced in a plasma and having molecules which intensely heat up spontaneously as a result of an impact with the electrons. This causes a breakup of chemical bonds and reactions which normally occur only at high temperatures. The substrate to be coated is normally, however, not subject to substantial thermal stress.

Another approach to achieve sufficient adhesion of the coating material involves the use of adhesion promoters. Adhesion promoters form molecular bridges on the interfaces between inorganic additives and an organic polymer matrix. They oftentimes contain hydrolyzable groups for binding onto inorganic material and organo-functional groups in the same molecule. Adhesion promoters are not only used for improving the adhesion of plastics but also of paints on metallic and other bases, or during production of composite films whose components do not undergo good adhesion with one another.

A drawback common to all these approaches is the need for a separate intermediate step between the production of the thermoplastic material and the coating process.

It would therefore be desirable and advantageous to provide an improved method for producing a coated thermoplastic material to obviate prior art shortcomings and to eliminate the need for an intermediate step or the need for application of an adhesion promoter or adhesive.

### SUMMARY OF THE INVENTION

According to one aspect of the present invention, a method for producing a coated thermoplastic material includes the steps of feeding thermoplastic material into a twin-screw extruder to produce a homogenous melt as the thermoplastic material is advanced, adding to the melt in plastic state an adhesion promoter for a coating material to be applied later, transferring the melt to an injection mold and allowing the melt to cure to form a thermoplastic body, and coating the thermoplastic body with the coating material.

According to another aspect of the present invention, a method for producing a coated thermoplastic material includes the steps of feeding thermoplastic material into a twin-screw extruder to produce a homogenous melt as the thermoplastic material is advanced, adding to the melt in plastic state a small amount of a coating material to be applied later as adhesion promoter, transferring the melt to an injection mold and allowing the melt to cure to form a thermoplastic body, and coating the thermoplastic body with the coating material.

The present invention resolves prior art problems by directly adding an adhesion promoter or a small amount of the coating material to a melt in plastic state by means of a twin-screw extruder. The addition of the adhesion promoter or a small amount of the coating material takes place simultaneously with the melting and the homogenization of the thermoplastic melt so that the admixing step is carried out in an already existing treatment step.

The additives are spread throughout the entire product, when the thermoplastic material has cured. This is inconsequential so long as the properties of the thermoplastic material are not impaired. The presence on the surface of the thermoplastic material of small amounts of the adhesion promoter or the coating material upon which or by which the material to be coated is able to firmly adhere and thus bond with the surface. As a result, there is no need for a separate intermediate treatment step in order to attain a good adhesion of a coating material onto a thermoplastic body.

An example of a coating material includes a polyurethane material comprised of a polyol component and isocyanate component. In particular such a polyurethane material adheres for example relatively poorly on a polypropylene or ABS material of a thermoplastic base body.

### BRIEF DESCRIPTION OF THE DRAWING

Other features and advantages of the present invention will be more readily apparent upon reading the following description of currently preferred exemplified embodiments of the invention with reference to the accompanying drawing, in which the sole FIGURE shows schematically a facility for carrying out the method for producing a coated thermoplastic material in accordance with the invention:

### DETAILED DESCRIPTION OF PREFERRED EMBODIMENTS

The depicted embodiment is to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

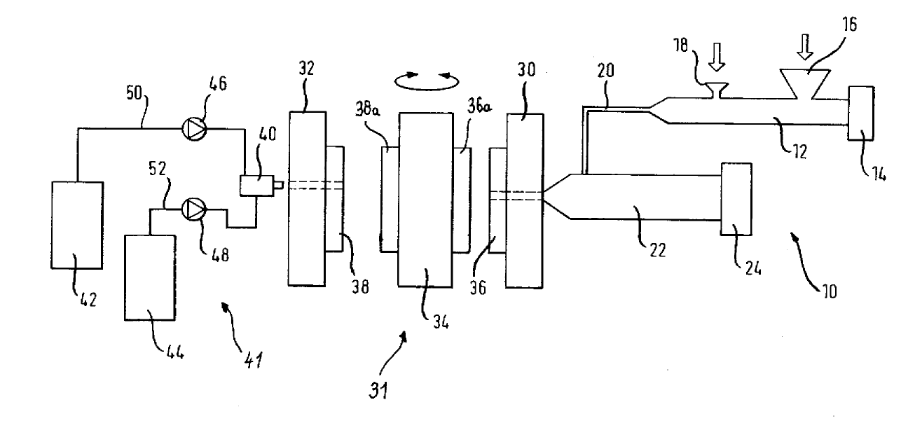

Turning now to the drawing, and in particular to FIG. 1, there is shown schematically a facility for carrying out the method for producing a coated thermoplastic material in accordance with the invention. The facility includes a plasticizing and injection device, generally designated by reference numeral 10, a clamping unit, generally designated by reference numeral 31, and a coating device, generally designated by reference numeral 41 for coating a thermoplastic base body with a polyurethane material. The plasticizing and injection device 10 includes a plasticizing unit 12 in the form of a twin-screw extruder having two screws (not shown) rotating in a same direction by a drive 14. Arranged in an entry zone of the twin screws is a hopper 16 via which thermoplastic material is introduced into the plasticizing unit 12.

Downstream of the feed hopper 16 is a further material feed 18 for introducing an adhesion promoter or an amount of polyurethane material, as indicated by the arrow. This component supplied via the further material feed 18 is incorporated homogenously into the plastic matrix of the thermoplastic material and evenly distributed up to the exit of the plasticizing unit 12. As it advances by the twin screws, the thermoplastic material is converted into a melt material which is fed at the end of the plasticizing unit 12 via a transfer line 20 to a separate injection unit 22 by which the melt is injected into a molding tool discontinuously and cyclically by means of a drive 24.

The clamping unit 31 is illustrated schematically in the FIGURE in the middle and includes two platens 30, 32 having half molds 36, 38, respectively mounted thereon. Two further half-molds 36a, 38a associated to and complementing the half-molds 36, 38 are arranged on an intermediate plate 34 which is constructed for rotation, as indicated by the rotation double arrow. The clamping unit is shown in open state, i.e. the confronting half-molds 36, 36a and 38, 38a are opened by moving the platens 30, 32 apart. In the closed state, both platens 30 and 32 are moved relative to one another towards the intermediate plate 34 so that the confronting half-molds 36, 36a and 38, 38a are fully closed, thereby forming two cavities in which material can be introduced via respective channels.

The polyurethane device 41 is schematically shown on the left-hand side of the FIGURE and includes a mixing head 40 which is connected via a feed line 50 with a container 42 containing a polyol component and via a feed line 52 with a container 44 containing an isocyanate component. The polyol and isocyanate components are respectively conveyed from the containers 42, 44 via interposed pumps 46, 48 to the mixing head 40. The polyurethane mixture is introduced from the mixing head 40 in plastic state into the cavity formed by the half-molds 38, 38a. The reaction mixture reacts there and cures.

The mode of operation of the overall facility will now be described:

Thermoplastic starting material—for example in form of pellets—is added to the plasticizing unit 12 via the feed hopper 16 and melted and homogenized by the operation of the plasticizing unit 12. Either an adhesion promoter for the subsequently added polyurethane material or a small amount of the polyurethane material in pre-mixed form is added to the plastic melt via the further material feed 18. The additives are mixed in homogeneously into the plastic matrix up to the end of the plasticizing unit 12. The thus-produced material is transferred from the end of the plasticizing unit 12 to the injection unit 22 for injection into the cavity formed by the closed half-molds 36, 36a. After the product has cured in the mold 36, 36a, a thermoplastic product is formed which is fully permeated either with the adhesion promoter or the polyurethane component. Adding only small amounts of this substance or material does not impair the property of the thermoplastic material.

After the thermoplastic material has cooled down, both molds 36, 36a and 38, 38a are opened and the intermediate plate 34 is rotated by 180°, when the clearance between the two platens 30, 32 is sufficient. When the clamping unit 31 closes again, a cavity is now formed between the half-molds 36, 36a on the right-hand side. Still contained on the left-hand side in the cavity between the half-molds 38, 38a which is mounted to the intermediate plate 34 is the previously produced thermoplastic product which is rotated as well in the half-mold 38a. The half-mold 38 on the platen 32 has a slightly greater cavity recess than the half-mold 36 on the platen 30 so that an intermediate space is formed between the cavity wall of the mold 38, 38a and the already formed thermoplastic product, when the mold 38, 38a is closed. A reactive polyurethane mixture is introduced into this intermediate space via the mixing head 40, when operating the pumps 46, 48, and overflows the thermoplastic product in the area of the newly formed cavity.

As a result of the adhesion promoter or the contained small amount of polyurethane material or adhesion promoter in the thermoplastic material and also on its surface, the introduced polyurethane material adheres in a superior way onto the surface, even when thermoplastic materials like polypropylene and ABS are involved.

Other procedures are, of course, also conceivable in order to introduce the adhesion promoter or the material being supplied in small amounts to the thermoplastic melt. This does not necessarily need to be carried out in the extruder. It may be added also in the injection unit or in the nozzle (for example with a static mixer). What is relevant is only that the additive is incorporated into the thermoplastic material before the thermoplastic material is injected into the cavity and before curing thereof.

In accordance with the present invention, the need for a separate treatment step between the two production steps, namely the molding of the thermoplastic product and the coating of the thermoplastic product, can thus be eliminated.

In addition to the described reversing plate principle for producing multi-component structures, the other known tool techniques for this process may also be used, e.g. indexing plate tools, sliding table tools, or rotary table tools with the respective and known injection molding machines.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for producing a coated thermoplastic material, comprising the steps of:
feeding thermoplastic material into a twin-screw extruder to produce a homogenous melt as the thermoplastic material is advanced;
adding to the melt in plastic state an adhesion promoter for a coating material to be applied later;
transferring the melt to an injection mold and allowing the melt to cure to form a thermoplastic body; and
coating the thermoplastic body with the coating material.

2. The method of claim 1, wherein the adhesion promoter is added to the melt, while the thermoplastic material is advanced in the twin-screw extruder.

3. The method of claim 1, wherein the adhesion promoter is added to the melt before being injected into the injection mold.

4. The method of claim 1, wherein the twin-screw extruder has two screws rotating in a same direction.

5. The method of claim 1, wherein the coating material is polyurethane (PUR) material.

6. The method of claim 5, wherein the polyurethane material contains a polyol component and an isocyanate component.

7. The method of claim 1, wherein the thermoplastic melt includes a material selected from the group consisting of polypropylene, polyethylene, and ABS material.

8. The method of claim 5, wherein the thermoplastic melt includes a material selected from the group consisting of PA, PBT, PC/ABS, ABS/PA, PC, PMMA, TPE, and TPU, and wherein the adhesion promoter is used with the PUR material for increasing the adhesion.

9. A method for producing a coated thermoplastic material, comprising the steps of:
feeding thermoplastic material into a twin-screw extruder to produce a homogenous melt as the thermoplastic material is advanced;
adding to the melt in plastic state a small amount of a coating material to be applied later as adhesion promoter;
transferring the melt to an injection mold and allowing the melt to cure to form a thermoplastic body; and
coating the thermoplastic body with the coating material.

10. The method of claim 9, wherein the adhesion promoter is added to the melt, while the thermoplastic material is advanced in the twin-screw extruder.

11. The method of claim 9, wherein the adhesion promoter is added to the melt before being injected into the injection mold.

12. The method of claim 9, wherein the twin-screw extruder has two screws rotating in a same direction.

13. The method of claim 9, wherein the coating material is polyurethane (PUR) material.

14. The method of claim 13, wherein the polyurethane material contains a polyol component and an isocyanate component

15. The method of claim 9, wherein the thermoplastic melt includes a material selected from the group consisting of polypropylene, polyethylene, and ABS material.

16. The method of claim 13, wherein the thermoplastic melt includes a material selected from the group consisting of PA, PBT, PC/ABS, ABS/PA, PC, PMMA, TPE, and TPU, and wherein the adhesion promoter is used with the PUR material for increasing the adhesion.
